(19) United States
(12) Patent Application Publication
(10) Pub. No.: US 2026/0036465 A1
(43) Pub. Date: Feb. 5, 2026

(54) Method for the Direct Measurement of Photon Energy and Gravitational Fields

(71) Applicant: Shannon Calvert, Easton, CT (US)

(72) Inventor: Shannon Calvert, Easton, CT (US)

(21) Appl. No.: 19/283,885

(22) Filed: Jul. 29, 2025

Related U.S. Application Data
(60) Provisional application No. 63/677,182, filed on Jul. 30, 2024.

(51) Int. Cl. G01J 1/44

(52) U.S. Cl. CPC G01J 1/44

(57) ABSTRACT

A method for direct measurement and profiling of electromagnetic energy from a star at a known distance from the observer entails collecting photons from the star with a camera through a telescope or lens of a given aperture area up to the known full well depth of the camera's image sensor, determining the time needed to reach the sensor's full well depth, using that collection time and the sensor's bandgap and sensitivity characteristics at full well depth to calculate the energy received per second through the aperture area, determining the number of aperture areas needed to cover the surface area of a sphere with a radius equal to the star's distance, and determining the total energy output of the star by multiplying the determined electromagnetic energy received through the aperture area by the number of apertures needed.

### BACKGROUND OF INVENTION

The present invention relates to determining the energy characteristics of celestial objects (primarily stars).

### SUMMARY OF INVENTION

According to the present invention, a method is provided for observing a celestial body such as a star at a known distance from an observation location includes using the full well depth of a camera's image sensor to measure photon energy received from the star by collecting photons from the star with the camera through a telescope or lens of a given aperture area and focal ratio up to the full well depth of the image sensor, determining the amount of time needed for the photon energy collected to reach the full well depth, determining the photon energy collected based upon the time needed, determining the number of telescopes or lenses with the given aperture area needed to cover a full area of a sphere with a radius equal to known distance of the star, and determining total energy output of the star by multiplying the determined photon energy received through the aperture area by the number of apertures needed. To elaborate, the present invention provides a method for using a camera's image sensor capacity or “full well depth” to measure photon energy at a known distance from an observation location by:
collecting photons from a star with a camera located at the known distance through a telescope or lens of a given aperture area and focal ratio up to the photoelectron capacity limit (the full well depth) of the image sensor,
determining the amount of time needed for the photon energy collected from the star to reach the full well depth of the image sensor,
determining the photon energy collected through the aperture based upon the time needed to reach the full well depth of the image sensor,
compensating for relevant factors such as sensor bandgap limitations, noise, quantum efficiency (QE), focal ratio of the telescope or lens, point spread functions (PSF), and atmospheric effects to calculate the stellar energy collected through the telescope or lens based on the time needed to reach the sensor's full well depth,
determining the number of telescopes or lenses with the above aperture area needed to cover the full area of a sphere with a radius of the star's known distance from the observation location,
determining total energy output of the star by multiplying the calculated photon energy the camera sensor received by the number of telescopes or lens apertures needed to cover the area of the sphere.

The foregoing summary is neither intended to define the invention of the application, which is measured by the claims, nor is it intended to be limiting as to the scope of the invention in any way.

### BRIEF DESCRIPTION OF THE DRAWING

The foregoing and further features of the present invention will be apparent from the following description of embodiments which are provided by way of example only in connection with the accompanying figures, of which:

FIG. 1 shows the shooting of a range of exposures of a star from shorter exposures to longer exposures until, for a given pixel, a pure white readout is reached at full saturation (the camera sensor's full well depth).

FIG. 2 illustrates sampling pixels to include adjacent photoelectrons at a point of full saturation.

FIG. 3 is a flowchart illustrating steps of the inventive method.

FIG. 4 shows some measured results, according to the method.

### DETAILED DESCRIPTION

The present invention is directed to the precise measurement of blackbody radiation from stellar objects of known distance by using a camera's sensor characteristics and full well depth to determine total energy output at different frequencies as a sort of “reverse standard candle.” With such measurements and proper modeling, these frequencies can also be used to describe and map gravitational fields according to my theory of photon momentum gravity detailed in Appendix A.

Astrophotography exposures are limited by a camera's full well depth. Any excess light energy results in blooming as the pixels become overexposed and photoelectrons spill into neighboring pixels. Since the camera sensor's full well depth and bandwidth can be accurately described, it's possible to take increasingly longer exposures of a given star until the full well depth is reached to find the number of photoelectrons received per second. Photographing that star from different locations would produce identical exposures via the photoelectric effect, so it follows that a sphere with a radius of that star's distance, when filled with identical cameras and lenses, could be used to determine total stellar energy at full well depth after compensating for bandgap limitations, noise, quantum efficiency (QE), focal ratio, point spread functions (PSF), and atmospheric effects.

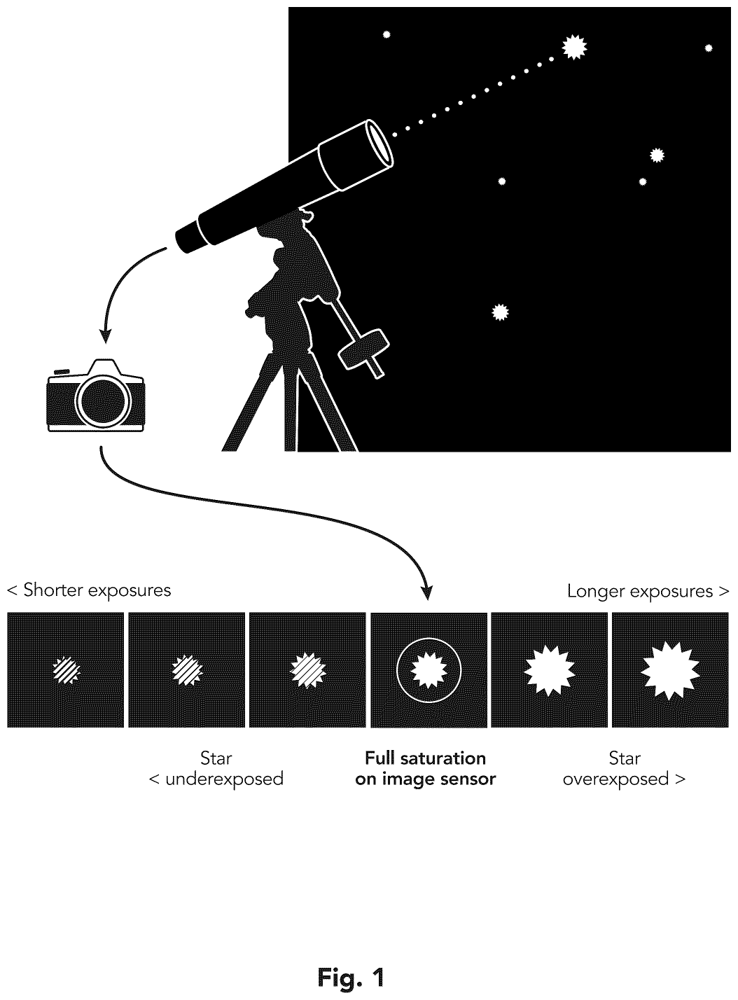

The method starts with a camera having a monochrome sensor with known or tested full well depth, and the chosen targets should not be significantly variable or binary to minimize fluctuating measurements. An RGB camera may be used with the caveat that its Bayer grid is not sensitive to all wavelengths at each subpixel and must be taken into account. An overexposed test image is taken to determine the RAW readout values for pure white (a completely filled sensor well). As illustrated in FIG. 1, a series of exposures is then taken of the target star with longer and longer shutter speeds until a central pixel reaches the readout values indicating overexposure.

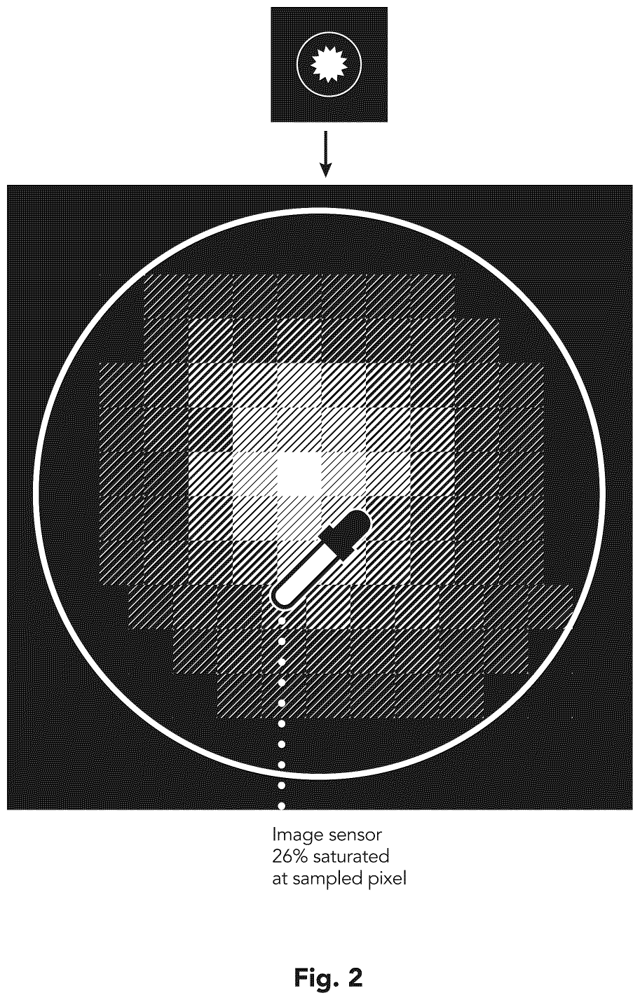

The shortest exposure with readout values indicating pure white means the incoming photon energy has reached the camera's full well depth. However, telescope optics cannot focus the light from a distant star into a single point, so a point spread function (PSF) or manual sampling is employed to include adjacent photoelectrons as a percentage of the full well depth readings (see FIG. 2). The sum of these readings is used to calculate total photoelectrons collected per second in an area equal to the telescope's objective lens or mirror.

An accurate distance to the star, such as those obtained through parallax measurements from the Gaia spacecraft, is used to calculate the surface area of a sphere with a radius of that stellar distance. Then divide the surface area of that sphere by the area of the measuring telescope's objective lens or mirror and multiply by the total photoelectrons received per second to calculate the energy emitted by that star.

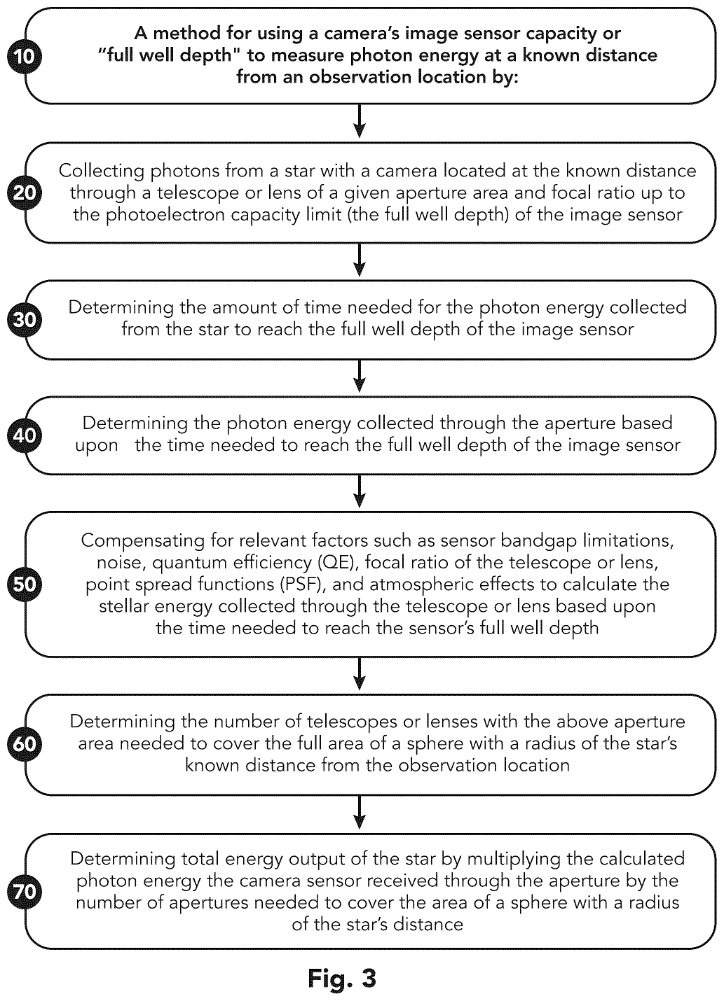

With reference to FIG. 3, a flowchart is shown illustrating a method 10 carried out according to the invention. As mentioned above, the present invention provides a method for using a camera's image sensor capacity or “full well depth” to measure photon energy at a known distance from an observation location by:
Collecting photons 20 from a star with a camera located at the known distance through a telescope or lens of a given aperture area and focal ratio up to the photoelectron capacity limit (the full well depth) of the image sensor,
Determining 30 the amount of time needed for the photon energy collected from the star to reach the full well depth of the image sensor,
Determining 40 the photon energy collected through the aperture based upon the time needed to reach the full well depth of the image sensor,
Compensating 50 for relevant factors such as sensor bandgap limitations, noise, quantum efficiency (QE), focal ratio of the telescope or lens, point spread functions (PSF), and atmospheric effects to calculate the stellar energy collected through the telescope or lens based on the time needed to reach the sensor's full well depth.
Determining 60 the number of telescopes or lenses with the above aperture area needed to cover the full area of a sphere with a radius of the star's known distance from the observation location.
Determining 70 total energy output of the star by multiplying the calculated photon energy the camera sensor received by the number of telescopes or lens apertures needed to cover the area of the sphere.

Given space telescopes with sensitivities ranging from gamma to far infrared such as JWST, Hubble, Chandra, Spitzer, etc., it's possible to use this method to measure not only stars, but planets and galaxies from outside the atmosphere at much broader bandwidths for more accurate modeling of photon energy. My theory of photon momentum (Appendix A) states that gravity is a quantized, emergent property of spontaneous photon emission determined by time dilation from blackbody temperature gradients. Therefore, the method described here can be used to map out the photon field at different wavelengths, which indicates the extent of time dilation at every point and potentially allows the mapping of spacetime itself.

For a test, I used an Astro-Tech EDT115 apochromatic triplet refractor, focused carefully with a Bahtinov mask, and chose 5 bright stars near zenith that weren't binary or significantly variable: 52 Cygni, Markab, Alkaid, Mirach, and Sadr. To minimize the influence of stray light and atmosphere, I chose the dark sky park at Cherry Springs, PA as the test site on a clear night close to new moon. Air temperature was below 10° C.

The listed full well depth of my 7D mark II camera sensor is 31,800 electrons/pixel at ISO 100, but for more accuracy, I tested my specific camera's full well depth with a module in Pixinsight and measured a more conservative reading of 30,159 electrons/pixel. The sensor also has a read noise of 15 electrons/pixel and a dark current of 0.016 electrons/pixel/second at 10° C. that doubles every additional 4.8° C. (negligible on this test).

An overexposed frame shows the 16-bit RGB readout values for pure white to be 32768, 32768, 32768 when the RAW images are sampled in Photoshop. So when the center of a star reaches those values in a series of increasingly long exposures, I know the pixel is saturated and the energy is at least that pixel's full well depth. I captured several frames at each exposure setting to confirm consistent results and chose the smallest, roundest star from each set for measurement.

Less than half of stellar radiation passes through the Earth's atmosphere, and silicon camera sensors are only sensitive to wavelengths shorter than 1110 nm. My modified camera has a Bayer color filter array that further narrows that bandwidth to 420-680 nm, with ⅔ of the wavelengths blocked at each subpixel, and a quantum efficiency of 59%. So my camera is blind to 57% of solar wavelengths and the QE only records 59% of the remainder. In addition, my telescope's f/7 focal ratio requires an exposure 49X longer than the same aperture with a 1:1 focal ratio, and the optics cannot focus light to a single pixel. To compensate for this “point spread function,” I opened the RAW files at default 16-bit values and sampled the RGB readout for each significantly-exposed pixel. A fully-exposed pixel reads 32768 for each channel for a total of 98304, which represents 100% of the 30159 electron full well depth. The readout sum divided by 98304 is the % of full well depth. Multiplying that % by 30159 (and then subtracting 15 for read noise) yields the total photons captured for each pixel.

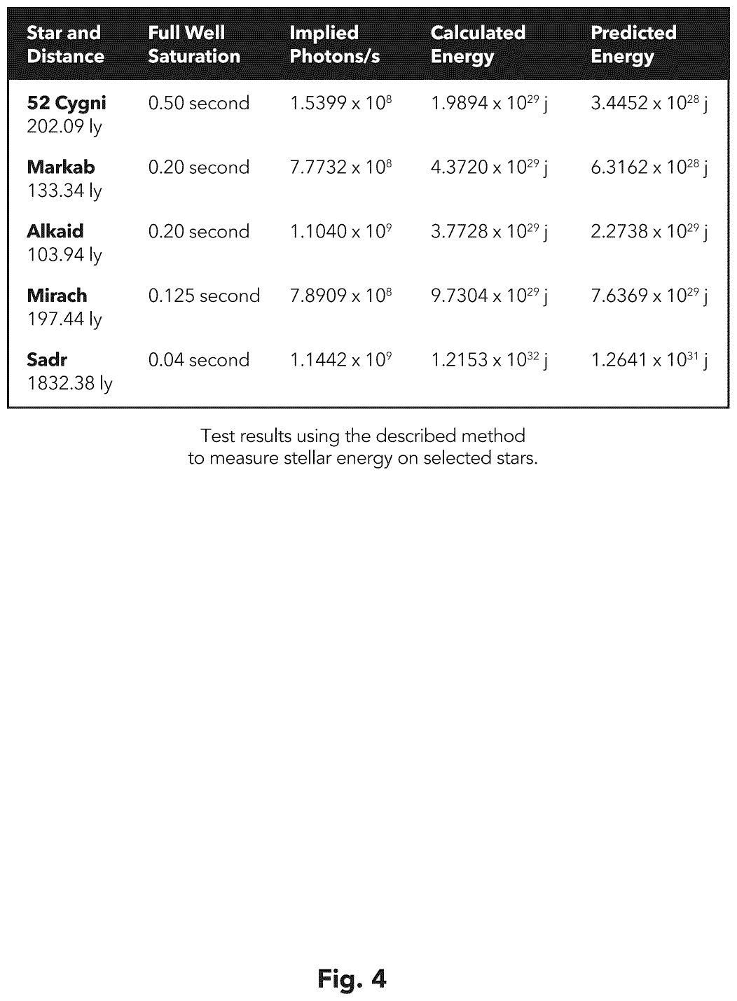

Measured results of the method are shown in FIG. 4. The first star, 52 Cygni, is 202.09 light years away (according to Gaia EDR3) and reaches full pixel saturation in 0.5 seconds. Correcting for a full second, adjacent pixels, and QE, my 115 mm telescope lens collects 3,142,742 photons/s of 420-680 nm wavelength from that star. A faster lens with the same aperture, but a focal ratio of 1:1, would therefore capture 153,990,000 photons/s. An identical telescope placed next to mine would capture the same number of photons, and a sphere with a radius of 202.09 light years would fit 4.4224×10³⁹ such lenses placed edge-to-edge (ignoring gaps between them). Those lenses would gather 6.81×10⁴⁷ photons every second. Each photon at the longest wavelength (680 nm) carries an energy of 2.92×10⁻¹⁹ joules, which implies a total energy of at least 1.99×10²⁹ joules. That's actually conservative since my camera only records a small fraction of the photons that reach the ground, it's not a monochrome sensor, I didn't count the full point spread, I ignored gaps in the stellar “lens” area, and I'm assuming the longest wavelength (average wavelength is probably 500 nm or less). For comparison, the Sun has an output of 3.828×10²⁶ joules, so I'm in the ballpark. Comparing the Sun's output to the radiance of the test stars shows that my crudely measured values are within a factor of 10 in every case (FIG. 4), which suggests this process is viable.

### APPENDIX A

Photon Momentum Gravity (phOMG)

SUMMARY: Gravity is the result of differences in time dilation that emerge from photon momentum as temperatures change over distance, which is largely dependent upon mass. The Planck constant is a universal quanta of energy for any photon, and redshift is a function of time dilation. The speed (c) and mass (0) of photons are constant, so changing the energy of a photon can only change the wavelength (time). Higher frequencies and shorter wavelengths mean the clock is ticking slower since more waves have time to pass before the next tick. This reconciles quantum mechanics with general relativity to create a unified field theory.

BACKGROUND: All matter above absolute zero spontaneously emits photons as thermal and blackbody radiation, and each of those photons carries momentum. This is literally a continuous loss of outward momentum in all directions at the speed of light-essentially “falling away” from every direction. Conservation of momentum dictates that all mass must gain a corresponding amount of inward momentum in every direction. Therefore, all matter in the universe has a constant, spontaneous inward acceleration, and the vector field of photon energy has a corresponding momentum field that is effectively a quantized, massless, spin-2 tensor field.

When a baseball or a car loses momentum, that loss of energy means it slows down. But photons always move at exactly the speed of light—they can't speed up or slow down. Instead, a photon that loses energy is redshifted. Under General Relativity, if mass is zero and speed stays constant, then losing energy means time must change (E=hc/λ) . . . and gravitational redshift is well established.

MECHANISM: A molecular cloud or other body emits photons from every particle above absolute zero as thermal emission. That's a loss of outward momentum for the photons that escape and a gain of momentum for any photons received from other particles. So the particles are falling inward and attracted toward each other in clumps.

As the body contracts, the pressure increases and it heats up due to Boyle's Law, radioactive decay, formation collisions, etc. Each “shell” of the body has a peak wavelength following Planck's Law. Electrons have more energy to reach higher orbitals at the core of the body and less at the surface. Photons emitted from higher orbitals correspond to higher frequencies and shorter wavelengths as in the Lyman, Balmer, Paschen series.

The energy of a photon may be described by E=hc/λ. The first two parts are constants, so only the wavelength can change. A photon with less energy has longer wavelengths while more energy means shorter wavelengths. Higher frequencies and shorter wavelengths mean the local clock is ticking slower since more waves have time to pass before the next tick. Thus, clock speed depends on frequency, frequency depends on temperature, and temperature depends on mass.

ALL the mass in a star or planet emits photons, which are constantly absorbed and re-emitted. Wavelengths are redshifted as you move outward from the core to faster ticking clocks at the surface (gamma to visible light for the sun, visible light magma to far infrared for the Earth or Moon). The emitted photon wavelengths represent different clock rates within the photon field as the frequency changes with temperature.

Clocks tick faster as you move away from the center of mass, and anything on that geodesic experiences gravity from the curvature of spacetime. The total mass determines maximum frequency, and the body's radius determines the rate of time dilation from the core to the surface. That's the “slope” of the gravitational well. Any photons received from neighboring bodies add more energy for electrons to reach higher orbitals, resulting in higher frequencies/slower clocks, and so the bodies move toward each other.

### APPENDIX B

Photon Momentum Gravity (phOMG) Examples

DARK ENERGY: Everywhere we look, galaxies appear to be redshifted. If photons are redshifted when they lose energy, then galaxies are redshifted simply by cooling off over time. Losing radiated photon momentum is literally “falling away” from every direction (expanding the space between bodies), and cooling off means longer and longer wavelengths, so there's an acceleration. Cosmic expansion is essentially a reverse Lorentz transformation.

This model can resolve the Hubble Tension, the varying Hubble constant, and fully formed galaxies 300 million years after the Big Bang. Given that gravity is a consequence of photon momentum, it's not surprising that gravitational waves propagate at exactly the speed of light (or that their wavelengths are so tiny).

DARK MATTER: In spiral galaxies, old inner stars tend to be redder while young, outer stars are bluer. Those photons are signaling a shift in the clock rate. The blue stars carry more momentum through time than the less energetic stars at the center. They have more kinetic energy and a stronger gravitational attraction to the galaxy. So there may be more mass at the center, but the time dilation behind gravity is disproportionately stronger in the arms. This explains why spiral galaxy rotation curves are skewed.

NEUTRON STARS AND OTHER HIGH-MASS OBJECTS: Neutron stars, quasars, black holes, and radio galaxies are the strongest sources of not only gamma and X-rays, but radio. The most powerful objects are also sources of the weakest photons because going from gamma to radio waves over the 10-15 km radius of a neutron star is a huge loss of momentum and a very steep gravitational well. Similarly, Fast Radio Bursts may be the time-dilated counterpart to extremely short wavelength gravitational waves from neutron star collisions. In a black hole, particles are accelerated toward the speed of light. The clock rate is already very slow with a steep gradient, and time essentially stops at the event horizon. That's like trying to drive a car with one side completely immobilized. Even if you're not receiving any light from the black hole, photons further away from the event horizon will always have a faster clock rate, so all paths through spacetime must curve inward-away from the faster flow of time.

EARTH'S OBLATE SHAPE: Isaac Newton declared that gravity is stronger at the poles due to centrifugal force and the equatorial bulge making the poles closer to the center of the Earth. However, the Earth is only spinning at one revolution per day (0.0034G). The radius is only 12 km shorter at the poles, while there's actually more mass beneath you at the equator, so those basically cancel out. A simpler explanation: the poles are cold. Therefore, they have a greater difference in blackbody photon wavelengths from core to surface than the equator, and that makes gravity stronger at the poles.

THE LUNAR GRAVITY ANOMALY: The largest and deepest impact crater on the Moon is the South Pole-Aitken basin. It's already colder than the lunar equator by geography, it's shaded even further from sunlight, and it's slightly closer to the core. This particular area coincides with anomalous measurements of stronger gravity as expected with photon momentum gravity.

PLANETARY ROTATION AND TIDAL LOCKING: The simple fact that the Sun warms one side of a moving planet likely explains planetary rotation, and the mild heating effect of earthshine/moonshine led the Moon to be tidally locked. The Sun and Mercury have a vastly more lopsided relationship and only yielded a mild resonance.

The exemplary embodiments are thus fully described. Although the description referred to particular embodiments, it will be clear to one skilled in the art that the invention may be practiced with variation of these specific details. Hence, this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

1. A method of observing a star from an observation location, comprising:
using a photoelectron capacity limit or full well depth of an image sensor of a camera to measure photon energy received from the star at a known distance from the observation location by:
collecting photons from the star with the camera located at the known distance through a telescope or lens of a given aperture area and focal ratio up to the photoelectron capacity limit or the full well depth of the image sensor,
determining the amount of time needed for the photon energy collected from the star to reach the photoelectron capacity limit or full well depth of the image sensor, determining the photon energy collected through the aperture based upon the time needed to reach the photoelectron capacity limit or full well depth of the image sensor,
determining the number of telescopes or lenses with the given aperture area needed to cover a full area of a sphere with a radius equal to known distance of the star from the observation location, and
determining total energy output of the star by multiplying the determined photon energy the camera sensor received through the aperture area by the number of apertures needed to cover the full area of the sphere with the radius equal to the known distance of the star from the observation location.

2. The method of claim 1, further comprising compensating the determined photon energy collected through the aperture for factors including one or more of:
sensor bandgap limitations, noise, quantum efficiency (QE), focal ratio of the telescope or lens, point spread functions (PSF), and atmospheric effects to calculate the photon energy collected through the telescope or lens based on the time needed to reach the photoelectron capacity or full well depth of the image sensor.
